(19) United States
(12) Patent Application Publication
(10) Pub. No.: US 2017/0329374 A1
(43) Pub. Date: Nov. 16, 2017

(54) Method for Controlling Fan in Tiny Computer

(71) Applicant: Top Victory Investments Ltd., Kowloon (HK)

(72) Inventors: David Huang, New Taipei City (TW); Jacky LIU, New Taipei City (TW)

(21) Appl. No.: 15/196,097

(22) Filed: Jun. 29, 2016

(30) Foreign Application Priority Data
May 12, 2016 (CN) 201610310376.1

(51) Int. Cl. G06F 1/20; G06F 9/44

(52) U.S. Cl. CPC G06F 1/206; G06F 1/203; G06F 9/4406

(57) ABSTRACT

The present invention discloses a method for controlling a fan in a tiny computer. The method controls the fan for a CPU according a DTS temperature of the CPU. If the CPU (or DTS) operates at a relatively low temperature less than or equal to a set temperature, the fan for the CPU stops running rather than always runs so as to reduce power consumption and noise caused by the running fan to provide a better user experience. It may increase useful time of the fan for the CPU, and reduce costs of customer service and maintenance.

### BACKGROUND OF THE INVENTION

### 1. Field of the Invention

The present invention relates to the field of tiny computers and, more particularly, to a method for controlling a fan in a tiny computer.

### 2. Description of the Prior Art

A conventional tiny computer, such as a Compute Stick developed by Intel Corporation, employs a cooling manner: a fan for a Central Processing Unit (CPU) always runs (at a full speed) after the tiny computer is powered on until the tiny computer is shut down.

When the CPU is idle and enters into a low utilization or power state, the fan for the CPU keeps on running (at the full speed), resulting in more power consumption and long-time noise caused by the running fan.

### SUMMARY OF THE INVENTION

The present invention provides a method for controlling a fan in a tiny computer according a DTS temperature of a CPU to reduce power consumption and noise caused by the running fan.

According to an aspect of the present invention, there is provided a method for controlling a fan in a tiny computer. The method includes the steps of:

(S1) powering on the tiny computer;

(S2) performing a Power-On Self-Test (POST) process handled by Basic Input/Output System (BIOS) firmware;

(S3) normally booting and running an operating system supporting Advanced Configuration and Power Interface (ACPI);

(S4) reading a Digital Thermal Sensor (DTS) temperature of a Central Processing Unit (CPU), and determining whether the DTS temperature is less than or equal to a set temperature; if yes, going to step S5; if no, going to step S6;

(S5) setting a corresponding register to turn off the fan for the CPU, and going back to step S3;

(S6) setting the corresponding register to turn on the fan for the CPU, and going back to step S3.

According to another aspect of the present invention, the tiny computer includes a Compute Stick.

According to another aspect of the present invention, the operating system supporting ACPI includes a Windows 10 operating system.

According to another aspect of the present invention, the set temperature includes 70 degree Celsius (° C.).

According to another aspect of the present invention, the corresponding register at steps S5 and S6 includes a General Purpose Input/Output (GPIO) register.

When the CPU is idle and enters into a low utilization or power state after the tiny computer is powered on, the method set the corresponding register to control the fan for the CPU according the DTS temperature of the CPU. If the CPU (or DTS) operates at a relatively low temperature less than or equal to the set temperature, the fan for the CPU stops running rather than always runs so as to reduce power consumption and noise caused by the running fan to provide a better user experience. It may increase useful time, such as Mean Time Between Failures (MTBF), of the fan for the CPU. In addition, it may further reduce costs of customer service and maintenance, such as costs of Field Application Engineer (FAE) and Return Merchandise Authorization (RMA).

### BRIEF DESCRIPTION OF THE DRAWINGS

FIG. 1 is a flowchart of a method for controlling a fan in a tiny computer according to an embodiment of the present invention.

### DESCRIPTION OF THE PREFERRED EMBODIMENTS

The embodiment of the present invention will now be further described below in detail in conjunction with the accompanying drawings.

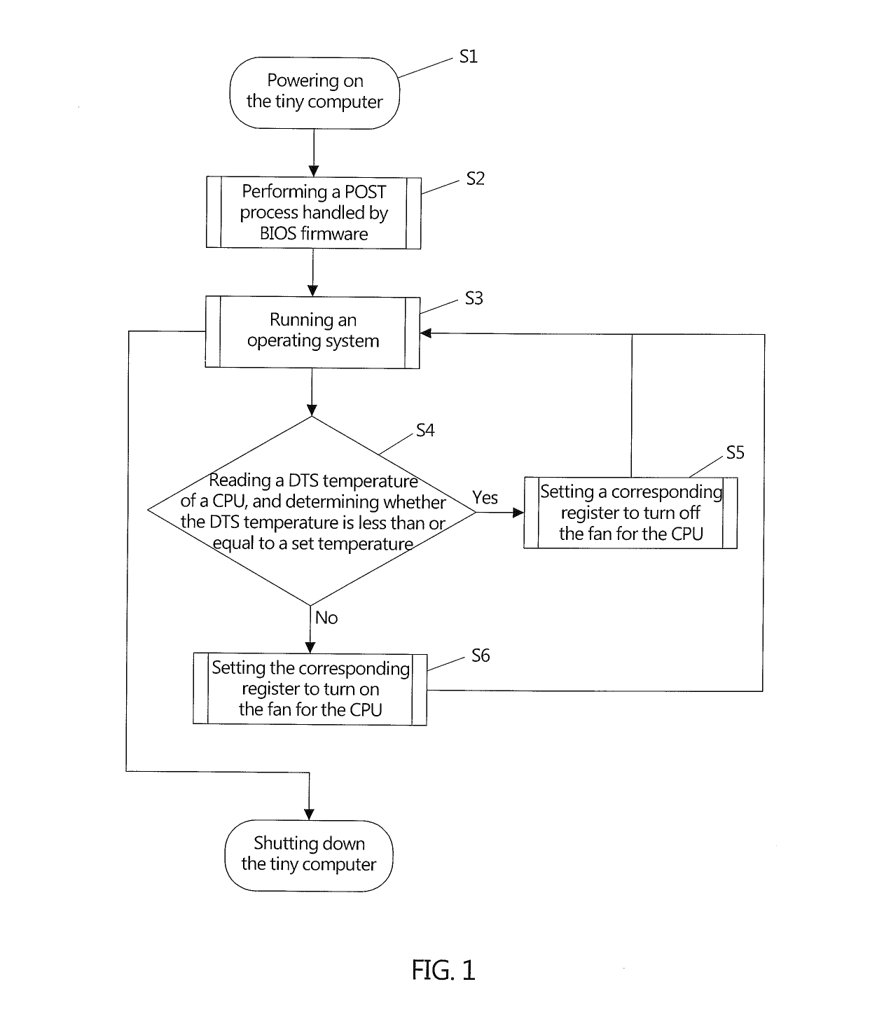

Referring to FIG. 1, there is shown a flowchart of a method for controlling a fan in a tiny computer according to an embodiment of the present invention. The method includes the steps of:

(S1) powering on the tiny computer;

(S2) performing a POST process handled by BIOS firmware;

(S3) normally booting and running an operating system supporting ACPI;

(S4) reading a DTS temperature of a CPU, and determining whether the DTS temperature is less than or equal to a set temperature; if yes, going to step S5; if no, going to step S6;

(S5) setting a corresponding register to turn off the fan for the CPU, and going back to step S3;

(S6) setting the corresponding register to turn on the fan for the CPU, and going back to step S3.

In an embodiment, the tiny computer may be a Compute Stick.

In an embodiment, the operating system supporting ACPI may be a Windows 10 operating system.

In an embodiment, the set temperature may be 70° C.

In an embodiment, the corresponding register at steps S5 and S6 may be a GPIO register.

In addition, when running the operating system at step S3, the tiny computer may be shut down once it receives a shutdown command, for example, by selecting the shutdown item from the start menu on the desktop in the Windows 10 operating system.

Although a conventional notebook computer employs a cooling manner capable of controlling the fan to turn on or off according to a temperature threshold, the circuit design of the notebook computer is more complicated, resulting that it needs many additional components, such as an embedded control chip or Super I/O chip, to implement the control of the fan. However, in the present invention, the tiny computer has extremely limited size, so it cannot employ the aforementioned embedded control chip or Super I/O chip to implement the control of the fan. Therefore, in the present invention, the tiny computer employs GPIO hardware of Intel X86 SOC/CPU and BIOS firmware using ACPI Source Language (ASL) to implement the control of the fan. It is noted that the present invention is adapted for the control of the fan of the tiny computer rather than a relatively large computer such as a notebook or desktop computer.

The tiny computer according to the present invention is different from the conventional tiny computer. The conventional tiny computer does not have a mechanism for the control of its fan. Its fan for the CPU always runs after the tiny computer is powered on until the tiny computer is shut down. Therefore, the tiny computer according to the present invention has many advantages: reduced power consumption and noise caused by the running fan to provide a better user experience, increased useful time, and reduced costs of customer service and maintenance.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A method for controlling a fan in a tiny computer, the method comprising the steps of:
(S1) powering on the tiny computer;
(S2) performing a Power-On Self-Test (POST) process handled by Basic Input/Output System (BIOS) firmware;
(S3) normally booting and running an operating system supporting Advanced Configuration and Power Interface (ACPI);
(S4) reading a Digital Thermal Sensor (DTS) temperature of a Central Processing Unit (CPU), and determining whether the DTS temperature is less than or equal to a set temperature; if yes, going to step S5; if no, going to step S6;
(S5) setting a corresponding register to turn off the fan for the CPU, and going back to step S3;
(S6) setting the corresponding register to turn on the fan for the CPU, and going back to step S3.

2. The method of claim 1, wherein the tiny computer comprises a Compute Stick.

3. The method of claim 1, wherein the operating system supporting ACPI comprises a Windows 10 operating system.

4. The method of claim 1, wherein the set temperature comprises 70 degree Celsius (° C.).

5. The method of claim 1, wherein the corresponding register at steps S5 and S6 comprises a General Purpose Input/Output (GPIO) register.
